(19) United States
(12) Patent Application Publication
(10) Pub. No.: US 2011/0309624 A1
(43) Pub. Date: Dec. 22, 2011

(54) DEVICE AND SYSTEM FOR EXTRACTING TIDAL ENERGY

(75) Inventors: Mohan Dass Ettanoor Thuppale, Singapore (SG); Charlie Chun Ta Chan, Singapore (SG); Shengyin Wang, Singapore (SG)

(73) Assignee: KEPPEL OFFSHORE & MARINE TECHNOLOGY CENTRE PTE LTD, Singapore (SG)

(21) Appl. No.: 13/203,762

(22) PCT Filed: Mar. 10, 2010
(86) PCT No.: PCT/SG2010/000081

§ 371 Date: Aug. 29, 2011

(30) Foreign Application Priority Data
Mar. 11, 2009 (SG) 200901681-7

(51) Int. Cl. F03B 13/10; F04D 27/00

(52) U.S. Cl. 290/54; 415/1

(57) ABSTRACT

A turbine assembly and a system for extracting tidal energy are disclosed. The turbine assembly may include identical sections disposed in a stacked arrangement. Each section may be shaftless, energizable by a fluid flow to produce lift and is appropriately oriented at a phase shift to an adjacent section such that a relatively constant resultant torque output with small amplitude fluctuation is generated by rotation of the turbine assembly. The turbine assembly may be employed in conjunction with a velocity enhancing device having a housing with variable profile openings to enhance the torque output. The turbine assembly may further be employed in a floating barrage arrangement which is transportable.

### BACKGROUND

1. Technical Field

Embodiments of the invention relate generally to systems and methods of extracting energy from a moving fluid, e.g. tidal currents, and more particularly to turbines capable of generating a relatively constant resultant torque output and systems employing such turbines and velocity enhancing devices.

2. Description of Related Art

Tidal power, or tidal energy, is a form of kinetic energy inherent in water currents or tides. A device that converts this kinetic energy into a useful form is known as a tidal current device. Many existing tidal current devices employ horizontal axis turbines akin to wind turbines. These horizontal axis tidal current turbines are large scale devices with diameters typically more than 10 meters and are designed to generate electrical power in the megawatt range so as to reduce the total infrastructure costs per megawatt. Consequently, these large scale turbines have to be operated in deep waters and at high tidal current flow speeds. As such, the potential applications of such large scale turbines are severely limited. Further, as tidal current flow changes direction twice a day, these large scale turbines require the use of complicated blade controls, sensors and other control equipment to achieve a higher efficiency.

Existing vertical axis turbines originating from Savonius, Darrieus or Gorlov designs have their limitations. Savonius designs operate as drag type turbines and therefore extract lesser power from moving fluids as compared to lift type turbines of similar sizes such as Darrieus and Gorlov designs. Vertical axis turbines normally generate sinusoidal torque output in a single revolution with the total number of peaks or troughs same as the number of blades. The sinusoidal torque outputs are caused by the summation of torques developed by individual blades, which vary depending on the position at which they interact with the flow during the revolution. These torque fluctuations would result in undesirable fluctuations of electrical output. In Gorlov helical turbine, blades are arranged in a helix in the vertical direction to distribute their cross-section evenly across fluid flow while rotating. However, Gorlov design is complex, costly to manufacture and has length limitation due to structural rigidity issues.

Tidal current turbines employed in tidal power stations are usually arranged in barrages which are constructed in river estuaries or span across an entrance of a lagoon. Such barrages are usually large-scale infrastructure, e.g. 750 meters in length, which requires high costs. Construction of barrages also has a negative environment impact of silting and altering the local ecosystem.

U.S. Patent No. 6,856,036 (Belinsky) discloses an installation for harvesting kinetic energy of ocean currents in deepwaters which is based on utilization of a semisubmersible platform and the multiple of vertically oriented Darrieus type hydraulic turbines with funnels. The turbines are located bellow sea level on distance sufficient to exclude them from being affected by wave actions. The electric power generators are located on a structure above water and transmit electric power to the shore utilizing flexible cable from semisubmersible to the sea bottom and underwater cable going to the shore, where it connected to the power distributing network. One of the Embodiments of this invention is designed to harvest energy of tides in deepwaters.

Additional information relating to turbines and systems employing turbines can be found in U.S. Pat. No. 6,921,986 (Bayer), WO 2008/050149 (Neptune Renewable Energy Limited), WO 2008/109784 (Saint Louis University), U.S. Patent Publication No. 2008/0084067 (Hill), U.S. Patent Publication No. 2008/0159873 (Tran), U.S. Patent Publication No. 2007/0269305 (Burg), U.S. Patent Publication No. 2007/0020097 A1 (Ursua), U.S. Patent Publication No. 2006/0008351 (Belinsky), U.S. Patent Publication No. 2003/0014969 (Walters), U.S. Pat. No. 4,717,832 (Harris), and U.S. Pat. No. 4,213,734 (Lagg).

In view of the above and other problems associated with existing turbine designs and turbine deployment, as well as the above-identified publications, improved turbine designs and systems and methods of deploying turbines are highly desired.

### SUMMARY

According to one embodiment of the invention, a turbine assembly may include identical sections disposed in a stacked arrangement. Outer plates may be disposed at opposed ends of the stacked arrangement. Each section includes a top surface, a bottom surface, and a plurality of airfoil-shaped blades fixedly mounted therebetween. A space within each section may be shaftless. The blades within each section may be arranged rotationally offset or displaced from blades within an adjacent section by a phase shift or an angle. With this rotational offset, each section is oriented at a phase shift to an adjacent section. When the sections are energized by a fluid flow to produce lift, the sections generate a plurality of progressively phase shifted torque outputs. Summation of the phase shifted torque outputs would result in a relatively constant resultant torque output with small fluctuations in amplitude.

Adjacent sections may be separated or interposed by an inner plate which prevents fluid communication between adjacent sections. Alternatively, adjacent sections may be interposed by a spokeless ring frame which allows fluid communication between adjacent sections.

The turbine assembly may be employed in conjunction with a velocity enhancing device which is oriented and configured to provide an accelerated fluid flow to the turbine assembly. According to one embodiment of the invention, a velocity enhancing device comprises a housing having multiple openings in fluid communication with one another. The openings may extend or even taper from two opposed ends of the housing towards a turbine chamber located therebetween. The housing may further provide an appropriately-dimensioned opening to allow placement of the turbine assembly into the turbine chamber and removal therefrom. The housing and turbine chamber may be suitably oriented to receive a vertically disposed or horizontally disposed turbine assembly.

Further, the velocity enhancing device may be provided with movable gates appropriately positioned at openings leading to the turbine chamber. The gates are actuatable by the force from a fluid flow to form an inlet profile for increasing fluid catchment at one of the openings which faces the fluid flow. As the gates are linked to maintain certain angular relationships with one another, formation of the inlet profile simultaneously actuates the counterpart gates to form an outlet profile, having a different geometry from the inlet profile, for diffusing fluid at another of the openings. When there is a change in direction of the fluid flow, the gates are actuatable by the force in the changed fluid flow to interchange the outlet profile with the inlet profile, and vice versa. Suitable linkages, such as a cable and pulley system, and a four-bar linkage may be provided between appropriate gates to maintain a predetermined angular relationship between the gates so that movement in one gate actuates its counterpart.

The velocity enhancing device may comprise multiple turbine chambers for receiving multiple turbine assemblies therein. The velocity enhancing device may be supported under a floating barge to form a barrage arrangement which is transportable to various locations.

### BRIEF DESCRIPTION OF THE DRAWINGS

Embodiments of the invention are disclosed hereinafter with reference to the drawings, in which:

FIG. 1A is a perspective view of a turbine assembly according to one embodiment of the invention;

FIG. 1B is a plan view of one section of the turbine assembly of FIG. 1A;

FIG. 2A is a perspective view of a turbine assembly according to one embodiment of the invention;

FIG. 2B is a plan view of one section of the turbine assembly of FIG. 2A;

FIG. 2C is a cross-sectional view taken from line C-C in FIG. 2B;

FIG. 3A is a perspective view of a velocity enhancing device according to one embodiment of the invention;

FIG. 3B is a perspective view of a turbine assembly housed in the velocity enhancing device of FIG. 3A;

FIG. 4 is a side cross-sectional view of a system for extracting energy from fluid motion according to one embodiment of the invention;

FIG. 5A is a velocity enhancing device having multiple turbine chambers arranged to receive turbine assemblies in a vertical position;

FIG. 5B shows multiple turbine assemblies vertically disposed in the velocity enhancing device of FIG. 5A;

FIG. 5C is a velocity enhancing device having multiple turbine chambers arranged to receive turbine assemblies in a horizontal position;

FIG. 5D shows multiple turbine assemblies horizontally disposed in the arrangement of FIG. 5C;

FIG. 6A is a simplified side view of a barrage having a velocity enhancing device arranged to receive fluid flow from direction A;

FIG. 6B is a simplified side view of a barrage having a velocity enhancing device arranged to receive fluid flow from direction B;

FIG. 6C is a simplified side view of a transition arrangement of the upper and lower gates during a change from the arrangement of FIG. 6A to FIG. 6B, or vice versa.

FIG. 6D is a side cross-sectional view of a turbine assembly disposed in a barrage of FIGS. 6A to 6C;

FIG. 7 is a plan sectional view of a barrage of FIG. 6B;

FIG. 8A is a graphical representation of the torque output generated from one of the sections of a turbine assembly; and

FIG. 8B is a graphical representation of progressively phase shifted torque outputs generated from various sections of a turbine assembly, and a summation of these progressively phase shifted torque outputs.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described.

It will also be understood that, although the terms “first”, “second” and etc. may be used herein to describe various components, these components should not be limited by these terms. These terms are only used to distinguish one component from another, without departing from the scope of the invention. Further, it is to be understood that the use of the term “one another” in the present description is not restricted to a context of having three or more; the term also applies to a context of having two or more.

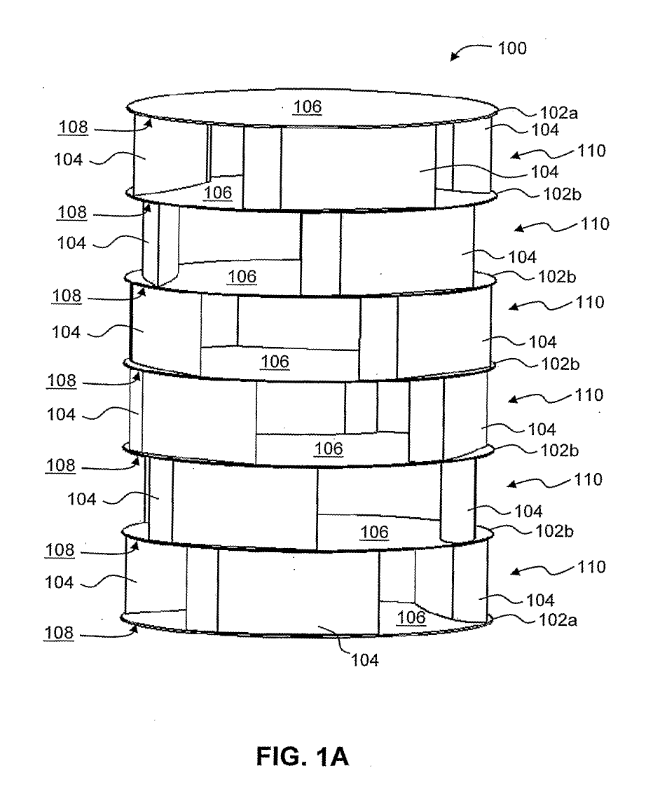

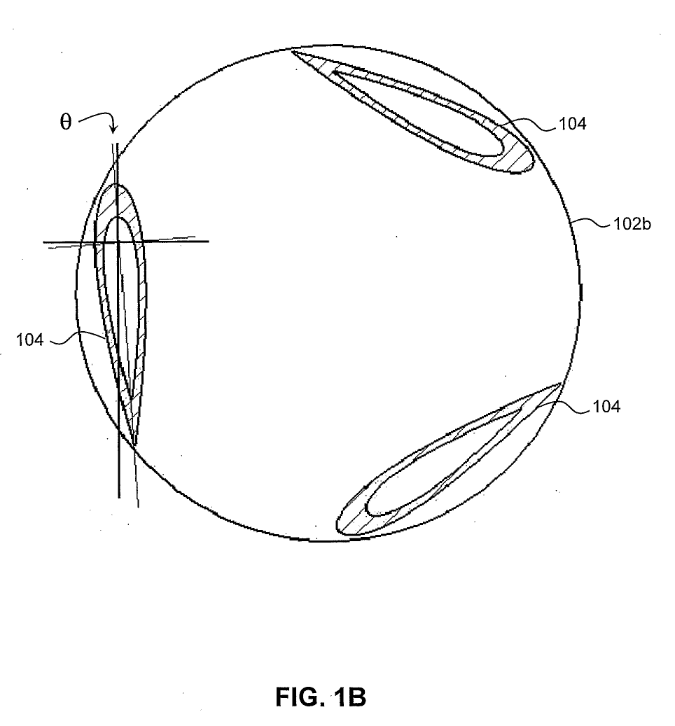

Reference is made to FIG. 1A which is a perspective view of a turbine assembly 100 according to one embodiment of the invention. The turbine assembly 100 may be formed of a plurality of identical sections 110 disposed in a stacked arrangement. Outer (circular) plates 102a are disposed at opposed ends of the stacked arrangement. Adjacent sections 110 may be separated or interposed by inner (circular) plates 102b which would prevent fluid communication and fluid cross-flow between adjacent sections 110. Other advantages associated with separating adjacent sections 110 using circular plates include, but are not limited to, improved structural rigidity of the turbine assembly 100, and reduction of vertical vortices which result in power loss.

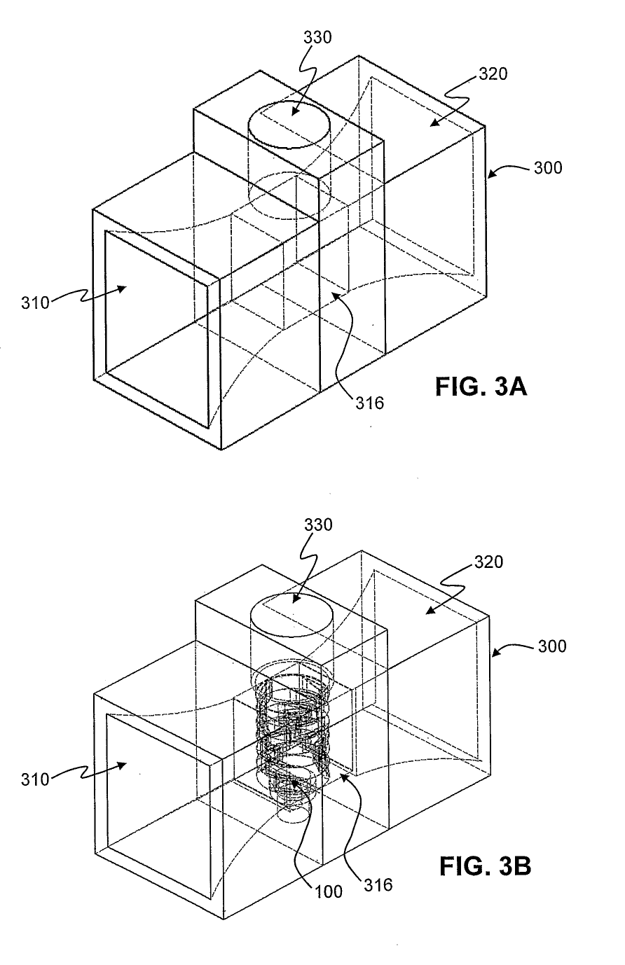

In each section 110, a plurality of blades 104 may be fixedly or immovably mounted between a top surface 106 of a circular plate and a bottom surface 108 of another circular plate. Each blade 104 may include an airfoil or hydrofoil shape having a leading edge and a trailing edge. The airfoil shapes may be symmetrical or asymmetrical, and selected from known airfoil profiles from various sources including, but not limited to, National Advisory Committee for Aeronautics (NACA). Selection of a suitable airfoil shape would depend on factors such as desired overall size, torque output and rotational speed of the turbine assembly 100. In one embodiment, the blades 104 may be oriented transversely to a direction of a fluid flow, i.e. tangential to a path of rotation. This position may be referred to as a tangential position. In certain other embodiments, however, each blade 104 may be tilted at an angle (θ) to orient its leading edge away from the tangential position, such as by 4°, to allow a positive angle of attack by a fluid flow (see FIG. 1B). It is to be appreciated that other angles of tilt may be applied as required. By tilting the blade 104 in relation to the tangential position, vortices are prevented from forming in each section 110 and thereby increasing torque output. Further, appropriately tilting the blade 104 would allow the optimization and/or reduction of the diameter of the circular plates and the width of the turbine chamber 316 of FIGS. 3A and 3B.

The blades 104 in each section 110 are discrete from one another and may be disposed in a relatively even distribution along or near a circumference or periphery of the section 110. In certain embodiments, chords of the airfoil-shape blades 104 may coincide with a chord of a circular plate 102b of each section 110. The blades 104 are appropriately oriented such that the turbine assembly 100 is to rotate uni-directionally under multi-directional flow. While the embodiment of FIG. 1B shows that each section 110 has three blades 104, it is to be appreciated that, in certain other embodiments, the number of blades 104 in each section 110 may be selected between two and six, or more as required. Further, the blades 104 in the each section 110 may be a hollow or a solid airfoil.

In FIG. 1A, the stacked arrangement forming the turbine assembly 100 is formed of six identical sections 110. The sections 110 may be oriented such that all blades 104 are unaligned to one another in a direction across the sections 110 or stacked arrangement. More particularly, the blades 104 within each section 110 may be arranged rotationally offset or displaced from the blades 104 of an adjacent section by a phase shift or an angle. The rotational offset or phase shift is progressive across the sections 110, such that a spiral effect may be observed across the various sections 110, both in the arrangement of the blades 104 and in the gaps between the blades 104 of a same section. This offset arrangement is to produce a relatively constant resultant torque output when the turbine assembly 100 is energized by a fluid flow. To illustrate further, when a fluid flow enters the turbine assembly 100, each of the section 110 is energized to produce lift. Due to the offset arrangement, a torque output generated by each section 110 is oriented at a phase shift to a torque output generated by an adjacent one of the sections 110. If the offset arrangement is evenly distributed over a full rotation, i.e., 360°, the peaks and troughs of the torque outputs generated by the various sections 110 would be evenly distributed. In other words, a plurality of progressively phase shifted torque outputs are generated by the sections 110, and a summation thereof would achieve a relatively constant resultant torque output. This relatively constant resultant output may be provided to an energy conversion device such as an electrical generator via one or more connecting shafts. The connecting shaft(s) may be connected to end plates of the stacked arrangement such that a space within each section 110 is generally free of a shaft or shaftless.

A phase shift between the progressively phase shifted torque outputs generated by each section 110 may be ascertained using the following formula:

Phase shift(°)=360°÷(number of blades in each section×number of sections)

According to one embodiment illustrated in FIGS. 1A and 1B in which the turbine assembly has six identical sections 110, each having three blades 104 arranged at a rotational offset of 120°, the phase shift of each section relative to an adjacent section may be calculated, using the above formula, as 20°. Accordingly, blades of adjacent sections are arranged at a rotational offset or displacement of 20°.

While FIGS. 1A and 1B show a turbine assembly having six identical sections 110 with each section 110 having three airfoil-shaped blades 104, it is to be appreciated that the invention is not limited as such. Other combinations of the numbers of sections 110 and blades 104 may be used in other embodiments of the invention.

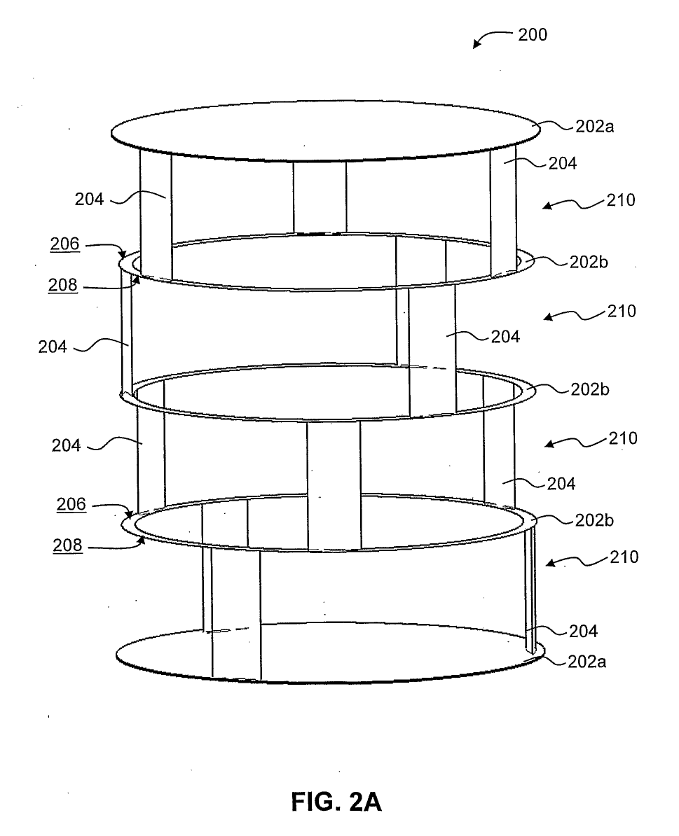

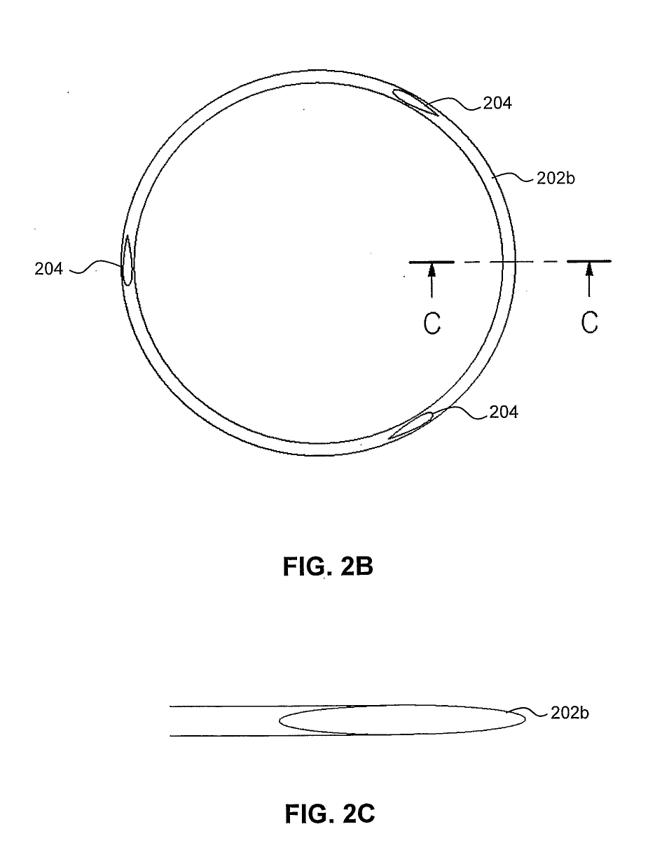

Reference is made to FIGS. 2A, 2B and 2C illustrating a turbine assembly 200 according to one embodiment of the invention. The turbine assembly 200 of FIGS. 2A, 2B and 2C are similar to the turbine assembly 100 of FIGS. 1A and 1B except for certain modifications described below.

In FIG. 2A, turbine assembly 200 includes two outer (circular) plates 202a disposed at opposed ends of the stacked arrangement. Adjacent sections 210 of the turbine assembly 200 may be separated or interposed by spokeless ring or annular frame(s) 202b. In some sections, a plurality of blades 204 may be fixedly mounted between a top surface 206 of a ring frame and a bottom surface 208 of another ring frame. In other sections, blades 204 may be fixedly mounted between an outer plate 202a and a ring frame 202b.

FIG. 2B shows a plan view of one section 210 of the turbine assembly 200. As illustrated, the spokeless ring frame 202b defines an opening which would allow fluid communication and fluid cross-flow between adjacent sections 210. The spokeless ring frame 202 reduces a surface area separating adjacent sections 210. Since large surface area separating adjacent sections would cause large windage losses which result in lower torque output, the use of spokeless ring frames results in smaller surface area separating adjacent sections and therefore reduces windage losses.

FIG. 2C shows a cross-sectional view taken from line C-C in FIG. 2B. As shown, the spokeless ring frame 202 may have an elliptical cross-section to avoid large boundary layer separation over the surface of the ring frame 202. Since boundary layer separation over a ring frame would create pressure drag which results in decreased torque output, an elliptical cross-section would result in smaller boundary layer separation over the surface of the ring frame and therefore smaller torque output reduction. However, it is to be appreciated that the cross-section of the spokeless ring frame 202 may take on other shapes.

The stacked arrangement forming the turbine assembly 200 of FIG. 2A is formed of four identical sections 210. Similar to the turbine assembly 100 of FIGS. 1A and 1B, blades 204 within each section 210 may be arranged rotationally offset or displaced from the blades 204 of an adjacent section 210 by a phase shift or an angle. The rotational offset or phase shift is progressive across the sections 210, such that a spiral effect may be observed across the various sections 210, both in the arrangement of the blades 204 and in the gaps between the blades 204 of a same section. This offset arrangement is to produce a relatively constant resultant torque output when the turbine assembly 200 is energized by a fluid flow.

According to the embodiment illustrated in FIGS. 2A and 2B in which the turbine assembly has four sections 210 where each section 210 has three blades 204 arranged at a rotational offset of 120°, the phase shift of each section 210 relative to an adjacent section may be calculated, using the above formula, as 30°. Accordingly, blades of adjacent sections are arranged at a rotational offset or displacement of 30°. It is also to be appreciated that other combinations of the numbers of sections 210 and blades 204 may be used in other embodiments of the invention.

According to one embodiment of the invention, a system for extracting energy from a fluid flow may comprise of a turbine assembly coupled to an energy conversion device such as an electrical generator. Further, a velocity enhancing device may be employed in conjunction with and appropriately oriented to the turbine assembly to provide an accelerated fluid flow through the turbine assembly. FIG. 3A illustrates an example of a velocity enhancing device which is employed to operate with a turbine assembly according to embodiments of the invention. It is to be appreciated, however, that other appropriate velocity enhancing devices may be employed with suitable modifications.

FIGS. 3A and 3B show a housing 300 having a first opening 310 disposed in fluid communication with a second opening 320. The first 310 and the second 320 openings are formed from two opposed ends and taper towards a constricted centre region. The first 310, second 320 openings and the centre region may be referred to as a venturi-shaped opening. The tapers may have a curved or straight profile adapted to accelerate a fluid flow entering from the first and/or the second opening and moving towards the centre region. The constricted centre region may house the turbine assembly 100 (or 200) and will be referred to as a turbine chamber 316. Depending on the direction of a fluid flow, the fluid flow may enter the housing 300 via the first 310 or the second 320 opening, move towards the turbine chamber 316 and through the other opening. This allows bi-directional operation of the turbine assembly 100.

The housing 300 further includes a third opening 330 formed from a top surface of the housing 300 and disposed in fluid communication with the turbine chamber 316. The third opening 330 may be suitably dimensioned to provide the turbine assembly 100 access to the turbine chamber 316. The third opening 330 may therefore allow a turbine assembly 100 to be lowered into the turbine chamber 316 during installation for operation and to be removed therefrom during un-installation for maintenance or repair. Hence, by providing the turbine assembly 100, the velocity enhancing device, i.e. housing 300, and an electrical generator as separate modules, installation and maintenance of the various modules would be less time and cost intensive. Since each module would have a lower individual weight, lesser heavy lifting equipment would be required.

The first opening 310, the second opening 320 and the turbine chamber 316 may have a cross-sectional profile which is selected from the group of shapes consisting of a rectangle, a square and a circle. However, a cross-sectional profile of other shapes may be applicable. The turbine chamber 316 may have a uniformly-dimensioned cross-sectional profile. The first opening 310, the second opening 320 and the turbine chamber 316 may have a plurality of cross-sectional profiles suitably dimensioned to achieve a desired rate of acceleration in a fluid flow moving towards the turbine chamber 316. In some embodiments, for example, a fluid flow entering the first 310 or the second 320 opening may be accelerated by between 1.2 and 3 times its free stream velocity before the fluid flow enters the turbine chamber 316. Hence, even at low free stream velocity conditions below 1 meter per second (m/s), torque output from a turbine assembly 100 can be enhanced by increasing the free stream velocity of a fluid flow before it enters the turbine assembly 100.

In one example, a housing 300 may have a length of around 11 meters, the first 310 and second 320 opening may have a width of around 4 meters and height of around 5 meters; and the turbine chamber 316 may have a width of around 2 meters and height of around 3 meters. Further according to this embodiment, a turbine assembly 100 may have a diameter of about 2 meters and a transverse length of about 3 meters. A turbine assembly 100 and housing 300 of this scale allow installation in shallow waters and therefore greatly enhancing potential applications of the invention. In this and certain other embodiments, the average torque output may be relatively constant with an amplitude fluctuation of about 2.5%.

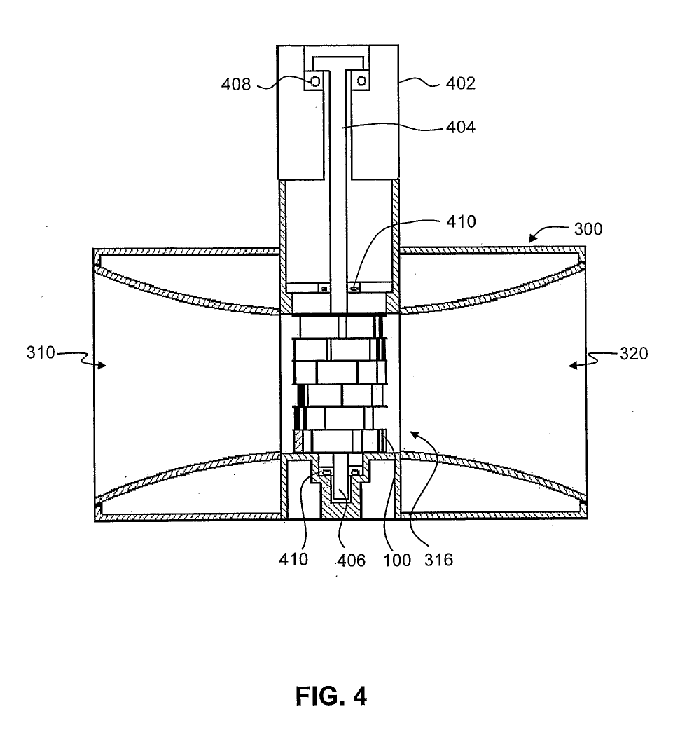

Reference is now made to FIG. 4 where a turbine assembly 100 disposed in a housing 300 as illustrated in FIG. 3B is arranged relative to an electrical generator upon installation for operation.

One or more shafts may be provided to couple the turbine assembly 100 to an electrical generator 402. In one embodiment, a first shaft 404 may be coupled to one end of the turbine assembly 100 and extending away from the turbine assembly 100 towards the electrical generator 402. More particularly, the first shaft 404 may be fixedly mounted to a first section and does not extend through a remainder of the sections 110. A second shaft 406 may be fixedly mounted to a last section, which is distal from the first section, and extending away from the turbine assembly 100 towards a bottom of the housing 300. Although both shafts are coupled to the end sections 110 of the turbine assembly 100, the shafts do not extend through the various sections 110 of the turbine assembly 100. Intermediate sections 110 are coupled to one another through partition plates 102 and airfoil blades 104. With this “shaftless” design within each section 110, undesired Magnus effect is prevented and vortex-induced vibrations are reduced, thus prolonging the lifetime of the turbine assembly 100. Accordingly; a greater volume of fluid flow is allowed through the sections 110 such that a higher fluid flow per unit of cross-section 110 area is achieved which result in higher energy extraction per unit time. Further, an absence of a shaft within each section 110 allows more space for marine animals to escape.

Torque generated by the turbine assembly 100 may be transmitted to one or more electrical generators 402 through a connecting shaft. The connecting shaft may be integral with or separate from the first shaft. The electrical generator 402 may be placed below or above water level; however, submerged electrical generators may require costly housing and sealing technology. In one embodiment where the electrical generator is placed above water level, the turbine assembly 100 may be suspended from or supported by the electrical generator's 402 thrust bearings 408. A plurality of thrust bearings 408 movably couple the connecting shaft of the turbine assembly 100 to the electrical generator housing, and support the weight of both the turbine assembly 100 and the connecting shaft. With the turbine assembly 100 suspended from the electrical generator 402, a plurality of guide bearings 410 may be required to prevent lateral movement of the turbine assembly 100 within the turbine chamber 316. To this purpose, a plurality of dry type guide bearings suitable for underwater applications may be employed. While other types of guide bearings may be used, dry-type guide bearings do not require man-made lubricants which would result in water pollution. The guide bearings 410 may be employed at two locations: near the bottom of the turbine assembly 100, and above the top of the turbine assembly 100. In certain embodiments where a turbine assembly 100 is connected to an electrical generator 402 via multiple shafts, the guide bearings 410 may be provided above the top of the turbine assembly 100 within the housing 300. In certain other embodiments, the connecting shaft can be chosen to suit the site, water depth and wave conditions, thereby allowing standardization of all other components. With the above-described arrangement of the thrust bearings 408 and guide bearings 410, three-point alignment of the turbine and electrical generator axes is achieved to provide rotational stability to the turbine. After converting mechanical or rotational energy from the turbine to electrical energy, the generated electrical energy may be conditioned to a suitable voltage for delivery to an onshore load either through underwater buried cables or overhead transmission lines.

In relation to the non-rotating components as described above, materials such as concrete, fibreglass, an inert material or combinations thereof may be used to prevent marine fouling problems. Further, the components may be coated with anti-fouling paints and applied with cathodic protection using sacrificial anodes. For the rotating components, such as the shafts, turbine assembly 100 including partitions and air-foil shaped blades 104, a corrosion resistant material may be used. Examples include, but are not limited to metal alloys. The rotatable components may be hollow or solid as required.

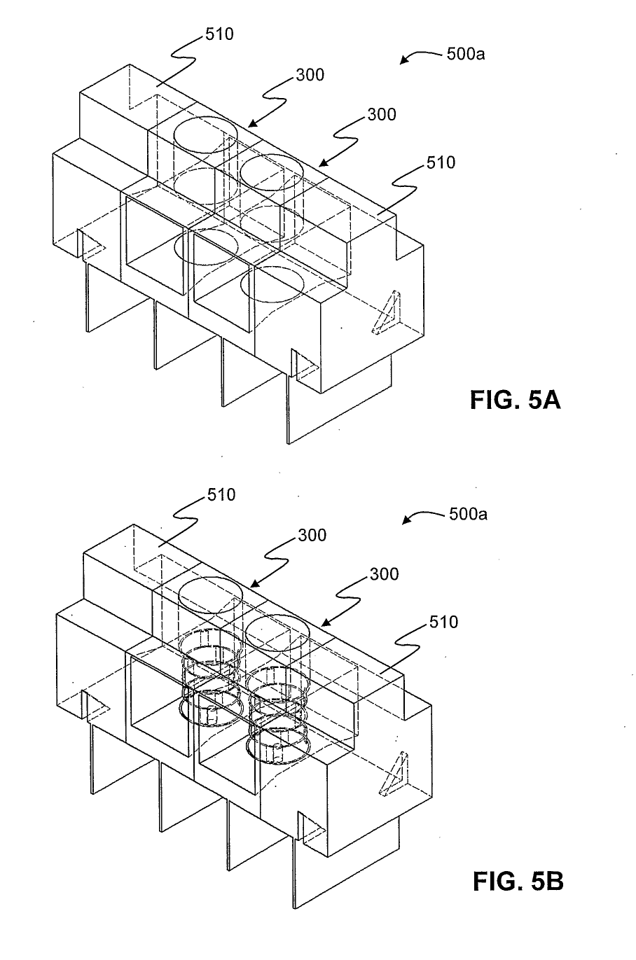

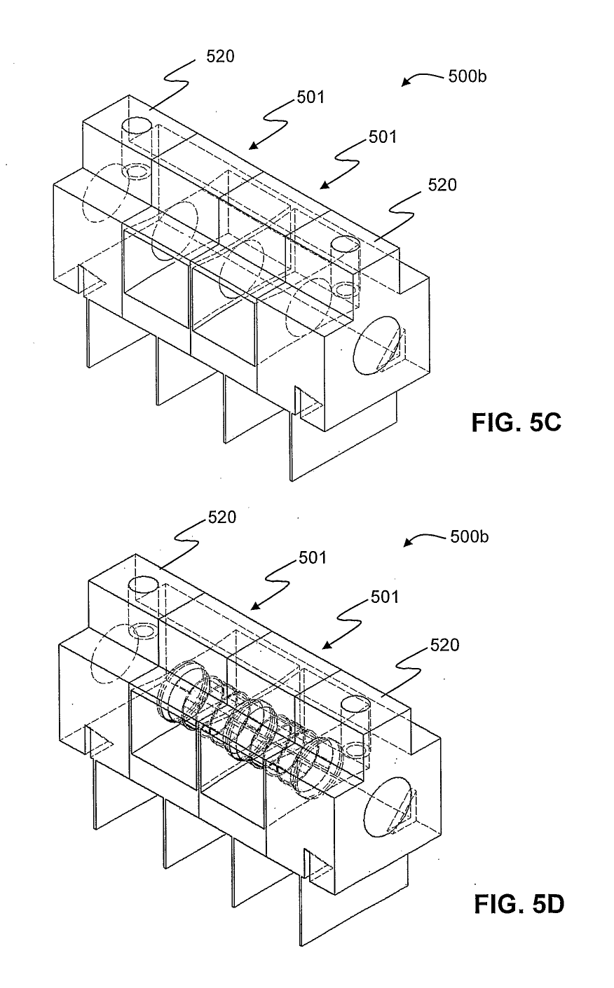

FIG. 5A shows a velocity enhancing device 500a having multiple turbine chambers arranged to receive multiple turbine assemblies in a vertical orientation. As illustrated in FIG. 5A, two units of the housing 300 of FIG. 3A are disposed in a juxtaposed arrangement which in turn is interposed between two side walls 510. The velocity enhancing device of FIG. 5A may be further coupled to a floating barge, vessel or floating structure (not shown), such as by suspension, attachment thereto, or integrally formed with a floating barge or structure.

FIG. 5B shows multiple turbine assemblies vertically disposed in the turbine chambers of FIG. 5A. For each turbine assembly disposed therein, one or more shafts may be provided to couple the turbine assembly to an electrical generator (similar to the foregoing description associated with FIG. 4). Alternatively, shafts extending vertically from each turbine assembly through the top opening of the turbine chamber may be coupled to a horizontally-disposed connecting shaft (not shown) which, together with bevel gears and other appropriate components, transmit individual torques generated from the turbine assemblies to one or more generators disposed on a floating barge. Since each turbine assembly does not require a dedicated electrical generator, the number of electrical components and costs can be reduced.

FIG. 5C shows a velocity enhancing device 550b having multiple turbine chambers arranged to receive multiple turbine assemblies in a horizontal position. In FIG. 5D, two units of a housing 501 (similar to the housing of FIG. 3A with suitable modifications) are re-oriented and disposed in a juxtaposed arrangement which is interposed between two side walls 520. Additional openings may be formed to allow installation and removal of turbine assemblies from the turbine chambers, and installation of shafts coupling the turbine assemblies. The velocity enhancing device of FIG. 5C may be further coupled to a floating barge, vessel or floating structure (not shown), such as by suspension, attachment thereto, or integrally formed with a floating barge or structure.

FIG. 5D shows multiple turbine assemblies horizontally-disposed in the turbine chambers 501 of FIG. 5C. Horizontally-disposed connecting shafts (not shown) may be provided to couple adjacent turbine assemblies together. The turbine assemblies may be coupled via bevel gears to vertically-disposed shafts which in turn transmit generated torques to an electrical generator located on a floating barge. Similarly, since each turbine assembly does not require a dedicated electrical generator, the number of electrical components and costs can be reduced.

In certain embodiments where the velocity enhancing device is coupled to a floating barge or vessel, a floating barrage arrangement may be formed. The floating barrage arrangement may comprise a floating barge, and a velocity enhancing device having one or more turbine chambers, turbine assemblies and electrical generators. The floating barrage may be relocated by towing to a desired location. As compared to a fixed barrage or a dam built across an estuary, a floating barrage which is transportable allows tidal energy to be harvested at greatly reduced construction costs and environmental costs.

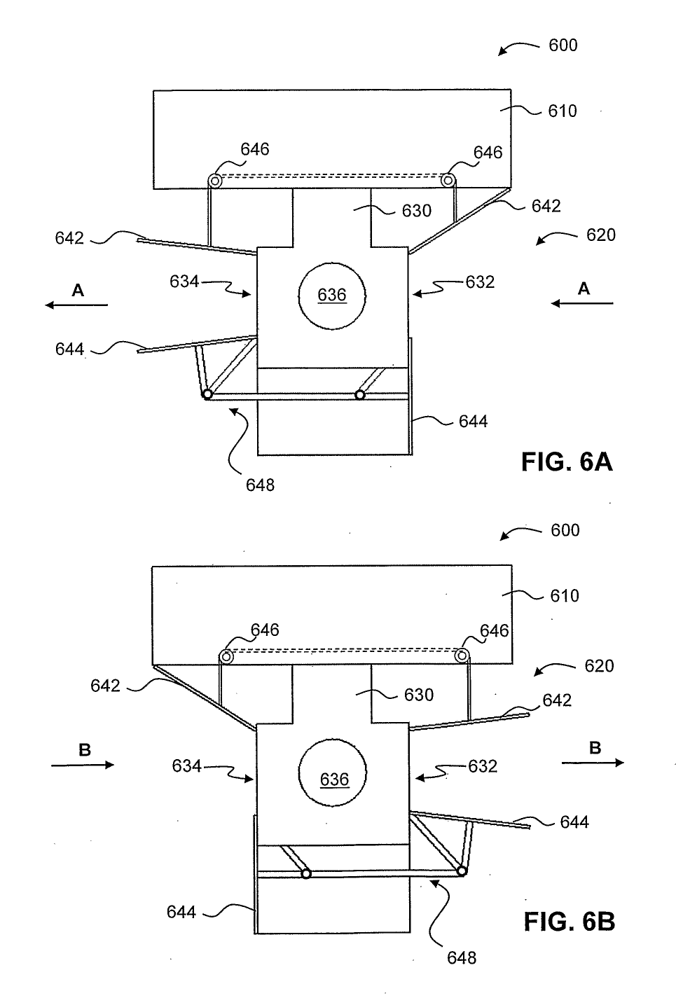

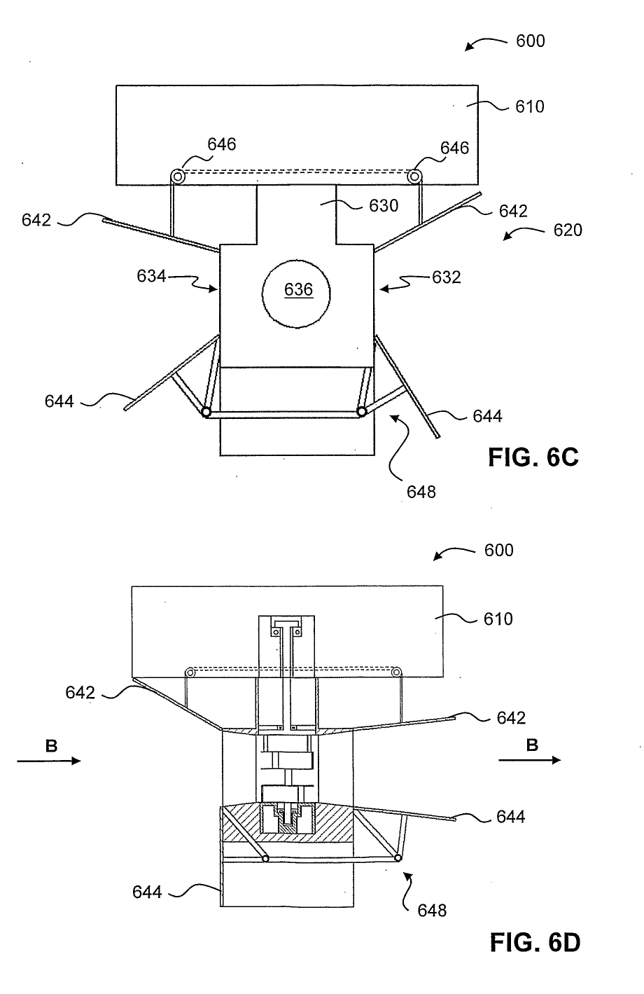

As illustrated in FIGS. 3A, 3B, 5A to 5D, openings at fluid inlets and outlets of the velocity enhancing devices have fixed profiles. In certain other embodiments, such as in FIGS. 6A to 6C, openings of velocity enhancing devices are provided with variable inlet and outlet profiles determined by a prevailing fluid flow direction.

Reference is made to FIG. 6A which shows a floating barge 610 supporting a velocity enhancing device 620 thereunder to form a floating barrage arrangement 600. The velocity enhancing device 620 includes a housing 630 having a first opening 632 disposed in fluid communication with a second opening 634. The first 632 and the second 634 openings are formed from two opposed ends and extend or taper towards a turbine chamber 636 therebetween for housing a turbine assembly. Depending on the direction of a prevailing fluid flow, the fluid flow may enter the housing 630 via the first 632 or the second 634 opening and move towards the turbine chamber 636. This allows bi-directional operation of the turbine assembly. Depending on the desired orientation (vertical or horizontal) of the turbine assembly, the housing may have other openings or structural modifications similar to FIGS. 3A to 3B and FIGS. 5A to 5B, or FIGS. 5C to 5D as described above.

As illustrated in FIG. 6A, at least two gates are provided at each of the openings of the housing 630. The gates are movably or pivotally coupled to the housing 630 at the upper and lower portions of the openings to allow fluid flow therethrough. The upper gates 642 are connected or linked in order to maintain a first angular relationship with one another. More particularly, upper gates 642 may be connected to each other by a pulley and cable system 646. Hence, if an inlet upper gate is lifted, the outlet upper gate will be lowered via the pulley and cable system 646, and vice versa. Further, lower gates 644 may be connected by a four-bar linkage 648 to maintain a second angular relationship with one another. Similarly, if an inlet lower gate is lowered, the outlet lower gate will be lifted via the four-bar linkage 648, and vice versa. The linkages 646, 648 allow gates to form variable profiles at the openings of the housing 630. It is to be understood that other types of linkages may be used in embodiments of the invention with suitable modifications.

In operation, pressure force of an incoming fluid flow pushes an inlet lower gate downwards to form a wall blockage (below the first opening 632). The lower gate may be disposed perpendicular to the fluid flow and prevented from over-rotation or being disposed under the turbine chamber 636 by ribs arranged thereunder (see FIG. 6A, FIGS. 5A to 5D) which are dimensioned to allow fluid flow under the turbine chamber in the absence of a blockage. The wall blockage prevents fluid flow and increases energy built-up at the inlet, thereby creating a barrage effect. At the same time, pressure force from the fluid flow also acts on the inlet upper gate to form a gradient or slope with a bottom of the barge 610. As the lower gates at the inlet and outlet are connected by a four-bar linkage 648, lowering of the inlet lower gate (at the first opening 632) will simultaneously actuate the outlet lower gate (at the second opening 634) to be lifted to form part of an outlet profile with an outlet upper gate. Similarly, lifting the inlet upper gate will simultaneously actuate the outlet upper gate to be lowered to complete the diffuser profile.

The inlet and outlet profiles have different geometries to achieve different purposes. The input profile is operable to increase fluid catchment (or increase depth of fluid catchment) by lowering the inlet lower gate to block the fluid flow, and direct fluid flow towards the turbine chamber by lifting the inlet upper gate to form a gradient or slope with the bottom of the barge. In cooperation with the tapered (or venturi-shaped) openings of the housing, an incoming fluid flow is accelerated before reaching the turbine chamber and turbine assembly disposed therein. The diffuser profile is operable to reduce adverse fluid pressure gradient, which will cause boundary layer flow separation, by forming an outlet geometry of about less than 20 degrees between the outlet upper and lower gates (or about less than 10 degrees between an outlet gate and the horizontal plane).

While FIG. 6A shows a fluid flow in a direction A; FIG. 6B shows an opposite fluid flow (in a direction B) which is operable to interchange the outlet profile with an inlet profile, and vice versa. In FIG. 6B, pressure force from a fluid flow in the direction B pushes an inlet lower gate at the second opening 634 to form a wall blockage (below the second opening 634). At the same time, pressure force from the fluid flow also acts on the inlet upper gate to form a slope with the bottom of the barge. As the lower gates are connected by a four-bar linkage, lowering of the inlet lower gate (at the second opening 634) simultaneously actuates the outlet lower gate (at the first opening 632) to be lifted to form part of a diffuser profile with an outlet upper gate. Similarly, the outlet upper gate (at the first opening 632) will be simultaneously lowered by the lifting of the inlet upper gate via the pulley and cable system to complete the diffuser profile.

FIG. 6C is a simplified side view of a transition arrangement of the upper and lower gates during a change in fluid flow direction.

FIG. 6D is a side cross-sectional view of a turbine assembly disposed in a barrage 600 of FIGS. 6A to 6C. A turbine assembly is vertically disposed in a turbine chamber and a connecting shaft vertically extends from the turbine assembly to connect to an electrical generator (not shown). These components are supported under a floating barge 610. A prevailing fluid flow in the direction B acts on gates at the inlet to form an inlet profile. Due to the respective linkages in the upper and lower gates, gates at the outlet are actuated to form a diffuser profile.

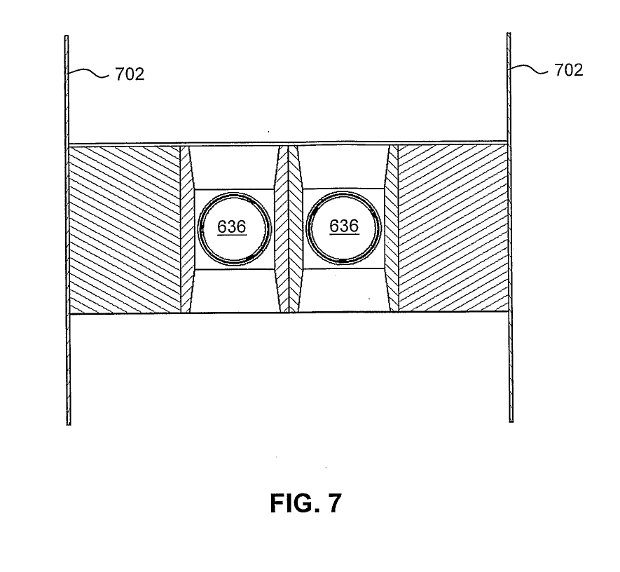

FIG. 7 is a plan sectional view of a barrage having two turbine chambers for receiving vertically-disposed turbine assemblies. The barrage includes end walls 702 interposing the velocity enhancing device and turbine chambers therebetween. The end walls 702 are operable to complement the inlet and outlet diffuser profile formed by upper and lower gates. More particularly, the end walls 702 would increase capture of free stream fluid at an inlet, and form part of the diffuser profile at the outlet to prevent formation of adverse fluid pressure gradient. Slots (see FIGS. 5A to 5D) may be formed in side walls of the barrage to accommodate the movement of the bar linkages of the lower gates. The barrage may be anchored in position to the seabed, such as by using concrete deadweight anchors.

A system for extracting energy from a fluid flow using the above-described components may be installed and operated as follows; however, it is to be appreciated that the described sequence may be modified or interchanged as required to install the arrangements illustrated in various Figures of the present description.

An appropriate underwater location is first identified for installing the system. This underwater location may be at a river stream, a coastal area, a sea, an ocean floor, a lake or any other locations in a liquid body or water body with sufficient depth and flow velocity. A velocity enhancing device, e.g. housing 300, 630, and linked gates arrangement, may be lowered into the water until the housing is at least partially submerged or resting on the underwater floor. The housing may be appropriately oriented in view of expected water current directions to allow water to enter the housing via the first and/or the second openings. The housing may be secured to the underwater floor by appropriate anchor methods or devices, e.g. using a gravity base, and/or suspended from a floating barge which may be anchored to the underwater floor.

A turbine assembly may be lowered into the housing via a roof opening until the turbine assembly is appropriately disposed in the housing. More particularly, the turbine assembly and housing are appropriately oriented such that the housing is to provide an accelerated fluid motion to a turbine assembly. After placement of the turbine housing and arrangement of the thrust and guide bearings, the turbine assembly may be at least partially submerged depending on water conditions. One or more shafts may be provided to connect the turbine assembly to an electrical generator. The electrical generator may be provided above water, such as on a barge, a vessel for water travel or a platform anchored to an underwater floor.

If maintenance or repair is required, the turbine assembly may be removed from the housing by lifting the turbine assembly through the roof opening. This eliminates the need to lift the entire system of the housing and turbine assembly, thus reducing maintenance or repair costs as well as downtime of the system. However, in certain embodiments, the housing and turbine assembly may be arranged or coupled such that both are lifted from underwater for maintenance or repair.

FIGS. 3B, 4 and 6D illustrate an orientation in which the turbine assembly operates with a vertical axis. It is to be appreciated that, in other embodiments of the invention, the system may be oriented differently such that the turbine assembly operates with a horizontal axis, e.g. FIG. 5B. In such embodiments, suitable modifications may be made. For example, a shaft connecting the turbine assembly to the electrical generator may have different orientations and, further, load bearings may be used instead of guide bearings.

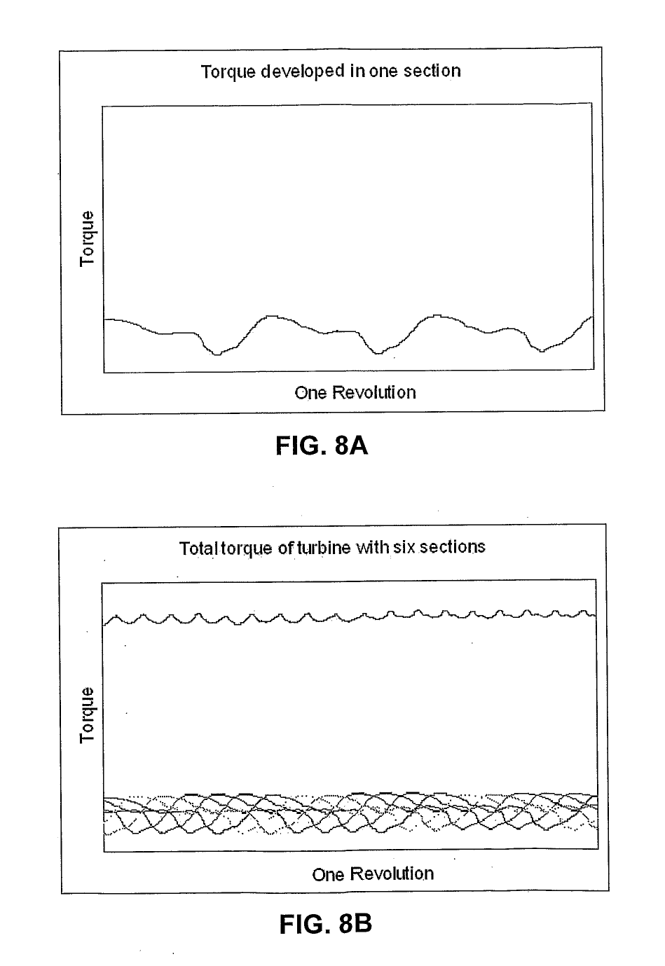

When the system is installed for operation, force from a fluid flow actuates linked gates to form an inlet profile for increasing fluid catchment at the inlet. The fluid flow entering into the housing from the first and/or the second opening is accelerated by the tapered walls of the openings before entering the turbine chamber. In response to forming of the input profile, the gates are further actuated by the angular relationships linking the gates to form a different outlet profile for diffusing fluid at the outlet. The accelerated water flow energizes the blades in the various sections of the turbine assembly and causes the turbine assembly to rotate. In one embodiment, the turbine assembly may rotate in a single direction regardless of the directions or change in directions of the fluid flow if the airfoil-shaped blades are positioned in a same clockwise or anti-clockwise direction. In each section energized by the fluid flow, a lift is produced which generates a torque output causing a rotational motion of the turbine. A torque output over one revolution developed in one of the sections may be represented by FIG. 8A in which the three peaks and three troughs of the illustrated waveform are developed by the three blades of a section. Progressively phase shifted torque outputs of the various sections and the summation thereof may be represented by FIG. 8B in which the amplitude of fluctuation in the resultant torque output is small or non-substantial.

When tide changes causing a change in direction of the fluid flow, the outlet profile is interchanged with the inlet profile, and vice versa.

Embodiments of the invention achieve various advantages which are not limited to those described in the foregoing paragraphs and in the following. The invention is capable of converting energy from ocean tidal currents into electricity over a wide range of tidal current velocities. Even in locations with low free stream velocities, sufficient torque can be generated thereby allowing for its deployment at locations not suitable for larger tidal devices. Such locations include, but are not limited to, shallow coastal areas and streams. Infrastructure costs associated with installing transmission cables would therefore be reduced if the invention is installed near to consumers of the electrical energy.

While the above paragraphs describe applications in a liquid body, e.g. water, it is to be appreciated that applications with other forms of fluid, e.g. wind, are applicable with suitable modifications.

Other embodiments will be apparent to those skilled in the art from consideration of the specification and practice of the invention. Furthermore, certain terminology has been used for the purposes of descriptive clarity, and hot to limit the embodiments as disclosed. The embodiments and features described above should be considered exemplary, with the invention being defined by the appended claims.

1. A system for extracting energy from a moving fluid, the system comprising:
a velocity enhancing device to provide accelerated fluid flow, comprising:
a housing having a plurality of openings disposed in fluid communication with one another, wherein the openings extend from two opposed ends of the housing towards a turbine chamber disposed therebetween; and
a plurality of gates linked to maintain a plurality of predetermined angular relationships among the gates, the gates being movably coupled to the housing, wherein the gates are actuatable by a fluid flow to form an inlet profile for increasing fluid catchment at one of the openings which faces the fluid flow, and in response to forming the inlet profile, the gates are actuatable by the angular relationships linking the gates to form a different outlet profile for diffusing fluid at another of the openings;
a turbine assembly disposed in the turbine chamber;
a shaft coupled to the turbine assembly; and
an electrical generator coupled to the shaft to convert rotational energy from the turbine assembly into electrical energy.

2. The system of claim 1, wherein the gates are actuatable by a change in direction of the fluid flow to interchange the outlet profile with the inlet profile, and vice versa.

3. The system of claim 2, wherein at least one of the gates forming the inlet profile is disposed perpendicularly to the fluid flow to block the fluid flow, and another of the gates forming the inlet profile provides a slope to direct the fluid flow towards the turbine chamber.

4. The system of claim 3, wherein at least two of the gates forming the outlet profile are angularly displaced from one another by less than about 20 degrees.

5. The system of claim 3, wherein each of at least two of the gates forming the outlet profile is angularly displaced from a horizontal plane by less than about 10 degrees.

6. The system of claim 1, wherein upper ones of the gates are linked by a pulley and cable system and lower ones of the gates are linked by a four-bar linkage.

7. The system of claim 1, wherein the velocity enhancing device is supported under a floating barge to form a transportable barrage arrangement.

8. The system of claim 7, wherein the floating barge includes a plurality of end walls interposing the velocity enhancing device therebetween, wherein the end walls are disposed to complement the inlet profile and the outlet profile formed by the gates.

9. The system of claim 1, wherein a plurality of ribs are arranged under the velocity enhancing device for preventing lower ones of the gates from being disposed under the turbine chamber.

10. The system of claim 1, wherein the housing having another opening disposed in fluid communication with the turbine chamber for installing and removing the turbine assembly therefrom.

11. The system of claim 1, further comprising a plurality of guide bearings movably coupled to the shaft to secure the turbine assembly to the housing.

12. The system of claim 1, further comprising a plurality of thrust bearings movably coupled to the shaft to secure the turbine assembly to the electrical generator.

13. The system of claim 1, wherein the turbine assembly is vertically disposed such that the shaft extends away from the turbine assembly in a vertical direction.

14. The system of claim 1, wherein the turbine assembly is horizontally disposed such that the shaft extends away from the turbine assembly in a horizontal direction.

15. The system of claim 1, wherein the turbine assembly includes:
a plurality of identical sections disposed in a stacked arrangement; and
two outer plates disposed at opposed ends of the stacked arrangement, wherein each of the sections includes:
a top surface, a bottom surface, and a plurality of airfoil-shaped blades fixedly mounted therebetween, and a space within the each of the sections is shaftless, and
wherein the blades within one of the sections are arranged rotationally offset from the blades within an adjacent one of the sections by a phase shift.

16. The system of claim 15, wherein adjacent ones of the sections are interposed by an inner plate operable to prevent fluid communication between the adjacent ones of the sections.

17. The system of claim 15, wherein adjacent ones of the sections are interposed by a spokeless ring frame operable to allow fluid communication between the adjacent ones of the sections.

18. A method comprising;
disposing a velocity enhancing device in a fluid body, the velocity enhancing device including:
a housing having a plurality of openings disposed in fluid communication with one another, wherein the openings extend from two opposed ends of the housing towards a turbine chamber disposed therebetween, and
a plurality of gates linked to maintain a plurality of predetermined angular relationships among the gates and movably coupled to the housing;
disposing a turbine assembly in the turbine chamber;
actuating the gates by a fluid flow to form an inlet profile for increasing fluid catchment at one of the openings which faces the fluid flow;
in response to forming of the input profile, actuating the gates by the angular relationships linking the gates to form a different outlet profile for diffusing fluid at another of the openings; and
generating a torque output in the turbine assembly energized by the fluid flow.

19. The method of claim 18, further comprising in response to a change in direction of the fluid flow, interchanging the outlet profile with the inlet profile, and vice versa.

20. The method of claim 19, wherein actuating the gates includes disposing at least one of the gates forming the inlet profile perpendicularly to the fluid flow to block the fluid flow, and disposing another of the gates forming the inlet profile as a slope to direct the fluid flow towards the turbine chamber.

21. The method of claim 20, wherein disposing a turbine assembly in the turbine chamber includes disposing a turbine assembly having:
a plurality of identical sections disposed in a stacked arrangement; and
two outer plates disposed at opposed ends of the stacked arrangement, wherein each of the sections includes:
a top surface, a bottom surface, and a plurality of airfoil-shaped blades fixedly mounted therebetween, and a space within the each of the sections is shaftless, and
wherein the blades within one of the sections are arranged rotationally offset from the blades within an adjacent one of the sections by a phase shift.

22. The method of claim 21, wherein disposing a turbine assembly in the turbine chamber includes disposing a turbine assembly having adjacent ones of the sections interposed by an inner plate which is operable to prevent fluid communication between the adjacent ones of the sections.

23. The method of claim 21, wherein disposing a turbine assembly in the turbine chamber includes disposing a turbine assembly having adjacent ones of the sections interposed by a spokeless ring frame which is operable to allow fluid communication between the adjacent ones of the sections.

24. The method of claim 18, wherein the fluid body is water.

25-36. (canceled)
